(19) United States
(12) Patent Application Publication
(10) Pub. No.: US 2014/0341321 A1
(43) Pub. Date: Nov. 20, 2014

(54) TRANSMITTER AND TRANSMISSION METHOD THEREOF

(71) Applicant: Institute For Information Industry, Taipei (TW)

(72) Inventors: Tsung-Yu TSAI, Tainan City (TW); Hsuan-Li LIN, Taipei City (TW)

(73) Assignee: Institute For Information Industry, Taipei (TW)

(21) Appl. No.: 14/279,024

(22) Filed: May 15, 2014

Related U.S. Application Data
(60) Provisional application No. 61/823,918, filed on May 16, 2013.

(51) Int. Cl. H04L 27/20

(52) U.S. Cl. CPC H04L 27/20
USPC 375/308; 375/302

(57) ABSTRACT

A transmitter and a transmitting method thereof are provided. The transmitter is configured to generate a first symbol sequence which includes a plurality of first symbols in which adjacent symbols correspond to different users, modulate the first symbol sequence into a second symbol sequence which includes a plurality of second symbols in which every two adjacent symbols correspond to one of the first symbols, and transmit the second symbol sequence. The transmitter is also configured to generate a first symbol sequence which includes a plurality of first symbols corresponding to a user, modulate the first symbol sequence into a second symbol sequence which includes a specific symbol and a plurality of second symbols, and transmit the second symbol sequence. The specific symbol and one of the second symbols correspond to one of the first symbols.

### PRIORITY

This application claims priority to U.S. Provisional Patent Application No. 61/823,918 filed on May 16, 2013.

### FIELD

The present invention relates to a transmitter and a transmission method thereof. More particularly, the present invention relates to a transmitter capable of performing differential modulation and a transmission method thereof.

### BACKGROUND

Machine type communications (MTC) have drawn much attention in recent years. In order to satisfy the potential communication demands between a base station and a machine, all of the next generation broadband communication systems (e.g., the communication systems specified by IEEE 802.16m, 3GPP LTE/LTE-A, and LTE release-12) support the machine type communications. Most of the machine type communications serve to provide transmission of small packets at a low transmission rate, so they are unsuitable for the next generation broadband communication systems which are designed to provide transmission of large packets at a high transmission rate. Therefore, adjustments need to be made to the next generation broadband communication systems to optimize the performance thereof in supporting machine type communications.

In a case where the signal to noise ratio (SNR) is very low (about −20 dB or less), the performance of channel estimation for various communication systems are greatly degraded. As compared with the channels, reference signals are distributed more sparsely, so usually the proportion of reference signals is increased in a communication system to maintain the accuracy of the channel estimation. However, once the proportion of reference signals is increased, not only the overhead of the system is greatly increased, but more time is required to collect the numerous reference signals.

In order to avoid degradation in the channel estimation, in the case where the SNR is very low, a communication system may also transmit data by means of a modulation technology which does not use the channel estimation (e.g., a differential modulation technology). In this way, the overhead of the system and the complexity of a receiving end can be reduced and the transmission rate can be improved. However, once a differential symbol sequence generated by the differential modulation is transmitted to a receiver, adjacent symbols in a data symbol sequence generated by the receiver through differential demodulation will be subjected to correlated noises due to the property of the differential modulation. Such correlation between the noises will degrade the performance of the receiver and increase the complexity of the receiver.

Accordingly, an urgent need exists in the art to reduce the correlation between the noises to which adjacent symbols of the data symbol sequence generated by the receiver through differential demodulation are subjected when a transmitter transmits data by using the conventional differential modulation technology.

### SUMMARY

A primary objective of certain embodiments of the present invention includes providing a transmitter and a transmission method thereof that can reduce the correlation between noises to which adjacent symbols of the data symbol sequence generated by the receiver through differential demodulation are subjected.

To achieve the aforesaid objective, the present invention according to certain embodiments, provides a transmitter which comprises a symbol sequence generating unit, a differential modulation unit and a transmitting unit. The symbol sequence generating unit of certain embodiments is configured to generate a first symbol sequence, wherein the first symbol sequence includes a plurality of first symbols in which adjacent symbols correspond to different users. The differential modulation unit of certain embodiments is configured to modulate the first symbol sequence into a second symbol sequence, wherein the second symbol sequence includes a plurality of second symbols in which every two adjacent symbols correspond to one of the first symbols. The transmitting unit of certain embodiments is configured to transmit the second symbol sequence to at least one of the users.

To achieve the aforesaid objective, the present invention further includes a transmission method for a transmitter, and the transmission method comprises the following steps of: generating a first symbol sequence by a symbol sequence generating unit, wherein the first symbol sequence includes a plurality of first symbols in which adjacent symbols correspond to different users; modulating the first symbol sequence into a second symbol sequence by a differential modulation unit, wherein the second symbol sequence includes a plurality of second symbols in which every two adjacent symbols correspond to one of the first symbols; and transmitting the second symbol sequence to at least one of the users by a transmitting unit.

According to the above descriptions, before the differential modulation, the transmitter and the transmission method described above can allocate adjacent symbols among the plurality of symbols included in the data symbol sequence to receivers of different users. As a result, the time interval at which a user receives his/her successive symbol is prolonged because the adjacent symbols are allocated to different users. Thus, the correlation between noises to which adjacent symbols among the symbols needed by each user are subjected is reduced. Therefore, with respect to the conventional differential modulation technology, the transmitter and the transmission method described above can effectively reduce the correlation between the noises to which the adjacent symbols of the data symbol sequence generated by the receiver through differential demodulation are subjected.

To achieve the aforesaid objective, the present invention further includes a transmitter which comprises a symbol sequence generating unit, a differential modulation unit and a transmitting unit. The symbol sequence generating unit is configured to generate a first symbol sequence, wherein the first symbol sequence includes a plurality of first symbols corresponding to a user. The differential modulation unit is configured to modulate the first symbol sequence into a second symbol sequence, wherein the second symbol sequence includes a specific symbol and a plurality of second symbols, and the specific symbol and any one of the second symbols correspond to one of the first symbols. The transmitting unit is configured to transmit the second symbol sequence to the user.

To achieve the aforesaid objective, the present invention further includes a transmission method for a transmitter, and the transmission method comprises the following steps of: generating a first symbol sequence by a symbol sequence generating unit, wherein the first symbol sequence includes a plurality of first symbols corresponding to a user; modulating the first symbol sequence into a second symbol sequence by a differential modulation unit, wherein the second symbol sequence includes a specific symbol and a plurality of second symbols, and the specific symbol and any one of the second symbols correspond to one of the first symbols; and transmitting the second symbol sequence to the user by a transmitting unit.

According to the above descriptions, the transmitter and the transmission method described above perform special differential modulation on the data symbol sequence so that the modulated differential symbol sequence comprises a specific symbol and a plurality of differential symbols. Each of the differential symbols is correlated to the specific symbol, and the differential symbols are independent from each other. In this way, the correlation between noises to which adjacent symbols of the data symbol sequence generated by the receiver through differential demodulation are subjected may be reduced. In other words, the correlation between the noises to which adjacent symbols among the symbols needed by each user are subjected will be reduced. Therefore, as compared to the conventional differential modulation technology, the transmitter and the transmission method described above can effectively reduce the correlation between the noises to which adjacent symbols of the data symbol sequence generated by the receiver through differential demodulation are subjected.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The following is a brief description of the drawings and is not intended to limit the present invention:

FIG. 1 is a schematic structural view of a transmitter 1 according to a first embodiment of the present invention;

FIG. 2 is a schematic view illustrating how a first symbol sequence 20 is modulated into a second symbol sequence 22 according to the first embodiment of the present invention;

FIG. 3 is a flowchart diagram of a transmission method according to a second embodiment of the present invention;

FIG. 4 is a schematic structural view of a transmitter 5 according to a third embodiment of the present invention;

FIG. 5 is a schematic view illustrating how a first symbol sequence 40 is modulated into a second symbol sequence 42 according to the third embodiment of the present invention; and

FIG. 6 is a flowchart diagram of a transmission method according to a fourth embodiment of the present invention.

### DETAILED DESCRIPTION

In the following description, the present invention will be explained with reference to certain example embodiments thereof. However, these example embodiments are not intended to limit the present invention to any specific examples, embodiments, environment, applications or implementations described in these embodiments. Therefore, description of these example embodiments is only for purpose of illustration rather than to limit the present invention. In the following embodiments and the attached drawings, elements unrelated to the present invention are omitted from depiction; and dimensional relationships among individual elements in the attached drawings are illustrated only for ease of understanding, but not to limit the actual scale.

A first embodiment of the present invention is a transmitter 1. The transmitter 1 is adapted for use in an environment with high noises (e.g., the SNR is less than −20 dB), but it may also be implemented in an environment with low noises. The transmitter 1 is adapted for use in various existing communication systems (e.g., the global system for mobile communication (GSM), and the general packet radio service (GPRS)) or in the next generation broadband communication systems (e.g., the communication systems specified by IEEE 802.16m, 3GPP LTE/LTE-A, and LTE release-12), or in various machine type communication systems.

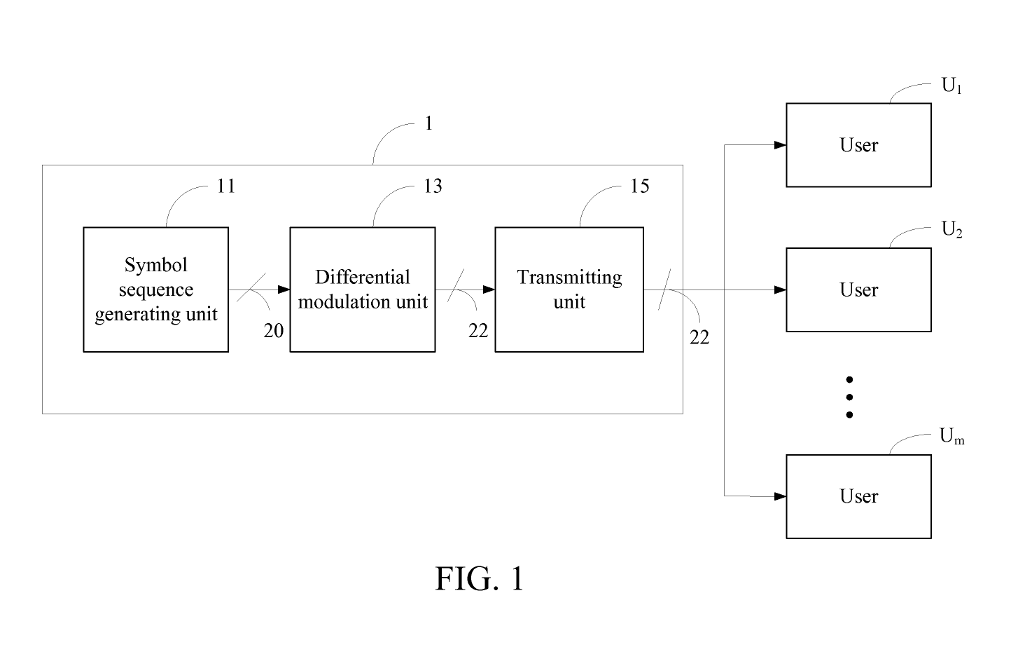

FIG. 1 is a schematic structural view of the transmitter 1 of this embodiment. As shown in FIG. 1, the transmitter 1 comprises a symbol sequence generating unit 11, a differential modulation unit 13, and a transmitting unit 15. The symbol sequence generating unit 11, the differential modulation unit 13, and the transmitting unit 15 are electrically connected to each other (either directly or indirectly) and can communicate with and transfer messages between each other.

The exemplary operation of the transmitter 1 will be further described hereinafter. Firstly, the symbol sequence generating unit 11 generates a first symbol sequence 20 including a plurality of first symbols, wherein adjacent symbols of the first symbols correspond to a plurality of different users (e.g., users U₁, U₂, . . . , Uₘ shown in FIG. 1). In this embodiment, the number of users may be two or more. Then, the differential modulation unit 13 modulates the first symbol sequence 20 into a second symbol sequence 22 including a plurality of second symbols, wherein every two adjacent symbols of the second symbols correspond to one of the first symbols. Finally, the transmitting unit 15 transmits the second symbol sequence 22 to at least one of the users.

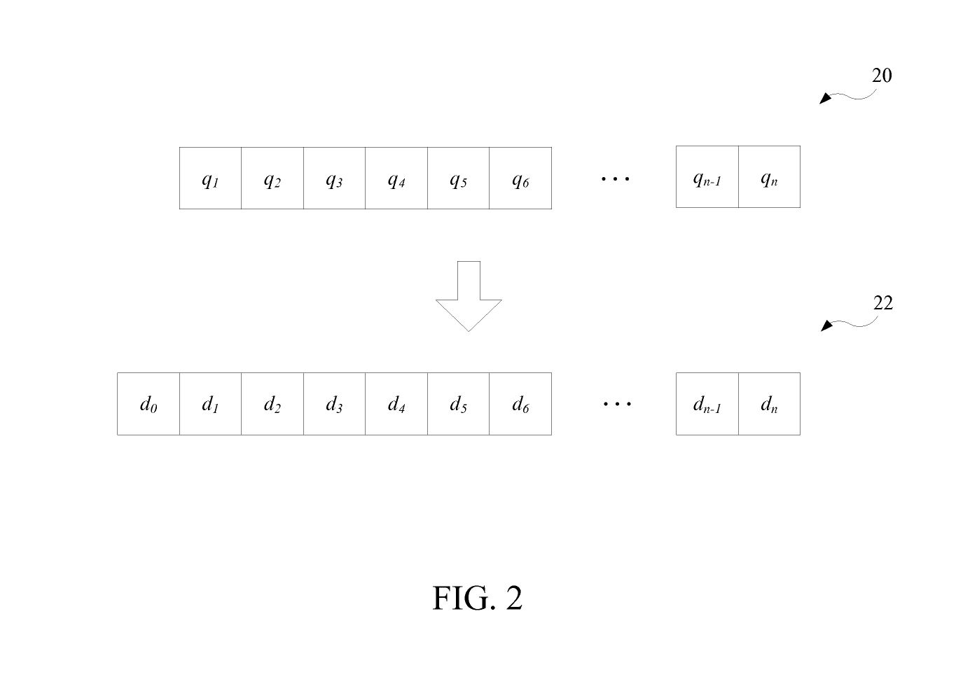

FIG. 2 is a schematic view illustrating how the first symbol sequence 20 is modulated into the second symbol sequence 22 according to this embodiment. As shown in FIG. 2, the symbol sequence generating unit 11 generates the first symbol sequence 20 including n first symbols q₁, q₂, . . . , qₙ. The first symbols q₁, q₂, . . . , qₙ are allocated to a plurality of different users alternatively so that every two adjacent first symbols correspond to different users.

For example, assuming that the transmitter 1 needs to make processing for two different users U₁ and U₂, then the symbol sequence generating unit 11 may allocate the odd-numbered first symbols q₁, q₃, . . . , qₙ₋₁ to the user U₁, and allocate the even-numbered first symbols q₂. q₄, . . . , qₙ to the user U₂. Alternatively, the symbol sequence generating unit 11 may allocate the odd-numbered first symbols q₁, q₃, . . . , qₙ₋₁ to the user U₂, and allocate the even-numbered first symbols q₂, q₄, . . . , qₙ to the user U₁.

As another example, assuming that the transmitter 1 needs to make processing for three different users U₁, U₂ and U₃, then the symbol sequence generating unit 11 may allocate the first symbols q₁, q₂, . . . , qₙ to the users U₁, U₂ and U₃ alternatively in various manners as long as every two adjacent first symbols correspond to different users. Similarly, assuming that the transmitter 1 needs to make processing for m different users U₁, U₂, . . . , Uₘ, then the symbol sequence generating unit 11 may allocate the first symbols q₁, q₂, . . . , qₙ to the different users U₁, U₂, . . . , Uₘ alternatively.

In this embodiment, each of the first symbols q₁, q₂, . . . , qₙ is an original data symbol. In other embodiments, each of the first symbols q₁, q₂, . . . , qₙ is a symbol that has been processed through various phase shift keying modulation schemes (e.g., 2PSK, QPSK, 8PSK, MPSK). In this case, the first symbols q₁, q₂, . . . , qₙ may be basically represented as e^{θ1}, e^{θ2}, . . . , e^{θ1}, and the θ₁, θ₂, . . . , θₙ correspond to different phases. Similarly, in other embodiments, the first symbols q₁, q₂, . . . , qₙ may also be symbols that have been processed through frequency shift keying modulation and amplitude shift keying modulation.

After the first symbol sequence 20 including the first symbols q₁, q₂, . . . , qₙ is generated by the symbol sequence generating unit 11, the differential modulation unit 13 performs differential modulation on the first symbol sequence 20 to generate the second symbol sequence 22. In detail, the differential modulation unit 13 may generate the second symbols d₀, d₁, . . . , dₙ according to the following equation:

d_{N}=conj(d_{N-1})q_{N}

where conj(*) represents a conjugate operation, d₀ is a preset value, d_{N} is the N^{th} of the second symbols, q_{N} is the N^{th} of the first symbols, and N is a positive integer.

Based on the aforesaid equation, after having determined the preset value d₀ (e.g., the absolute value of d₀ may be set to be equal to the absolute value of q₁), the differential modulation unit 13 can generate the second symbol d₁ according to the preset value d₀ and the first symbol q₁. Then, the differential modulation unit 13 may generate the second symbol d₂ according to the second symbol d₁ and the first symbol q₂, and so on, until the (n+1)^{th} second symbol dₙ is generated.

If one of the users U₁, U₂, . . . , Uₘ intends to receive corresponding first symbols that he or she needs after the second symbol sequence 22 is generated by the differential modulation unit 13, the transmitting unit 15 transmits the second symbol sequence 22 to the receiver of the user. After the second symbol sequence 22 is received and differential demodulated by the receiver of the user, the corresponding first symbols needed by the user can be obtained according to the aforesaid rules based on which the first symbols q₁, q₂, . . . , qₙ are allocated to the user by the symbol sequence generating unit 11. The differential demodulation is an inverse of the aforesaid differential modulation and can be readily appreciated by those of ordinary skill in the art, and thus will not be further described herein.

Through the aforesaid operations of the transmitter 1, the first symbols correlated to each user will not be adjacent to each other after the second symbol sequence 22 is received and demodulated by the receiver of each user. Thus, the time interval at which each user receives his/her successive first symbols will be prolonged so that the correlation between the noises to which the first symbols correlated to each user are subjected can be effectively reduced. In other words, the transmitter 1 can effectively reduce the correlation between the noises to which adjacent symbols of the data symbol sequence generated by the receiver through differential demodulation are subjected.

In other embodiments, the transmitter 1 may further comprise a spreading unit (not shown), wherein the spreading unit may be electrically connected to the transmitting unit 15, and spread each of the second symbols in one of the time domain and the frequency domain by using various spreading codes before the second symbol sequence 22 is transmitted by the transmitting unit 15. In this way, the noises can be effectively suppressed, the transmission delay of the packet can be reduced remarkably, and electric power can be saved. As considering the operation of the spreading unit at the transmitter 1, after the second symbol sequence 22 is received by the receiver of each user, a despreading operation and the aforesaid differential demodulation will be performed in succession on the second symbol sequence 22 so as to obtain the corresponding first symbols needed. In this embodiment, the transmitting unit 15 transmits the second symbols d₀, d₁, . . . , dₙ via a single antenna (not shown). In other embodiments, the transmitting unit 15 may also comprise a plurality of antennas (not shown) which are used to transmit the second symbols d₀, d₁, . . . , dₙ alternatively. Transmitting the second symbols d₀, d₁, . . . , dₙ via a plurality of antennas can generate a diversity gain and thereby improve the performance. For example, if the transmitting unit 15 comprises a first antenna and a second antenna, the transmitting unit 15 may transmit the odd-numbered second symbols d₀, d₂, . . . , dₙ via the first antenna and transmit the even-numbered second symbols d₁, d₃, . . . , dₙ₋₁ via the second antenna. In other embodiments, the transmitting unit 15 may also transmit the second symbols d₀, d₂, . . . , dₙ via any one of a plurality of antennas randomly.

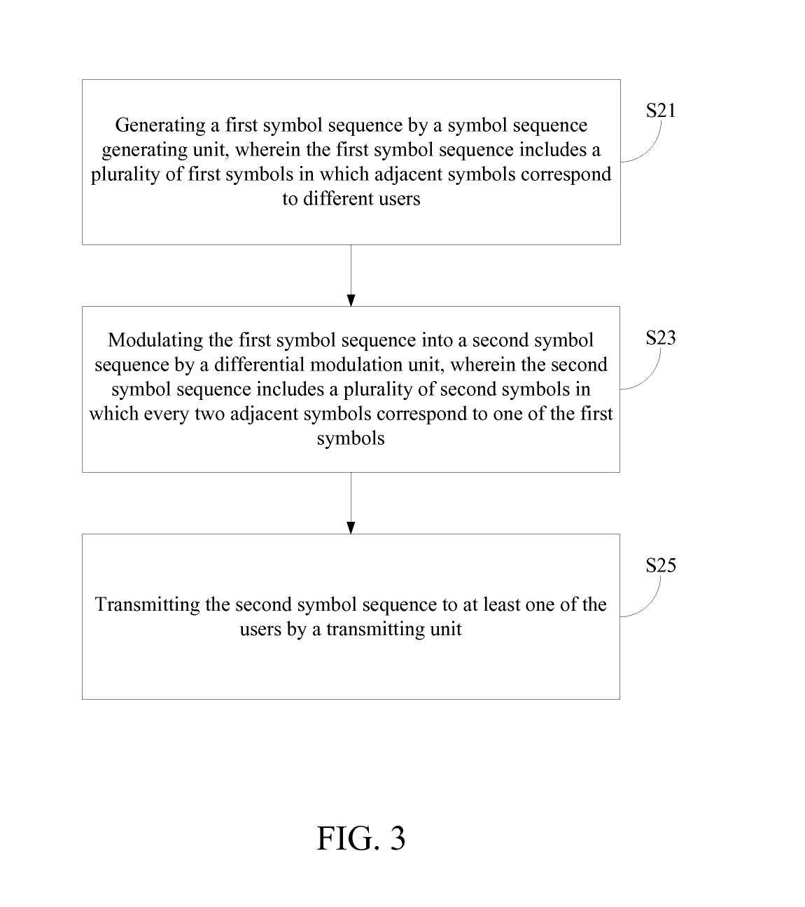

A second embodiment of the present invention is a transmission method for a transmitter (e.g., the transmitter 1 of the first embodiment). FIG. 3 is a flowchart diagram of the transmission method of this embodiment. As shown in FIG. 3, step S21 is executed to generate a first symbol sequence by a symbol sequence generating unit, wherein the first symbol sequence includes a plurality of first symbols in which adjacent symbols correspond to different users. Step S23 is executed to modulate the first symbol sequence into a second symbol sequence by a differential modulation unit, wherein the second symbol sequence includes a plurality of second symbols in which every two adjacent symbols correspond to one of the first symbols. Step S25 is executed to transmit the second symbol sequence to at least one of the users by a transmitting unit.

In other embodiments, the differential modulation unit generates the second symbols according to the following equation:

d_{N}=conj(d_{N-1})q_{N}

where conj(*) represents a conjugate operation, d₀ is a preset value, d_{N} is the N^{th} of the second symbols, q_{N} is the N^{th} of the first symbols, and N is a positive integer.

In other embodiments, the transmission method of this embodiment further comprises the following step of: spreading each of the second symbols in one of the time domain and the frequency domain by a spreading unit before the second symbol sequence is transmitted by the transmitting unit.

In other embodiments, the step S25 further comprises the following step of transmitting the second symbols by a plurality of antennas alternatively.

In other embodiments, each of the first symbols is a symbol processed through phase shift keying modulation.

In addition to the aforesaid steps, the transmission method of this embodiment can further execute all the operations and functions corresponding to the transmitter 1 of the first embodiment. The undisclosed steps of this embodiment will be readily appreciated by those of ordinary skill in the art based on the explanation of the first embodiment, and thus will not be further described herein.

According to the above descriptions, the transmitter 1 of the first embodiment and the transmission method of the second embodiment may allocate adjacent symbols of the plurality of symbols included in the data symbol sequence to receivers of different users before the differential modulation. As a result, because the adjacent symbols are allocated to different users, the time interval at which each user receives his/her successive symbols is prolonged. Thus, the correlation between the noises to which adjacent symbols among the symbols needed by each user are subjected is reduced. Therefore, as compared to the conventional differential modulation technology, the transmitter 1 of the first embodiment and the transmission method of the second embodiment can effectively reduce the correlation between the noises to which adjacent symbols of the data symbol sequence generated by the receiver through differential demodulation operation are subjected.

A third embodiment of the present invention is a transmitter 5. The transmitter 5 is adapted for use in an environment with high noises (e.g., the SNR is less than −10 dB), but it may also be implemented in an environment with low noises. The transmitter 5 is adapted for use in various existing communication systems (e.g., the global system for mobile communication (GSM), and the general packet radio service (GPRS)) or the next generation broadband communication systems (e.g., the communication systems specified by IEEE 802.16m, 3GPP LTE/LTE-A, and LTE release-12), or in various machine type communication systems.

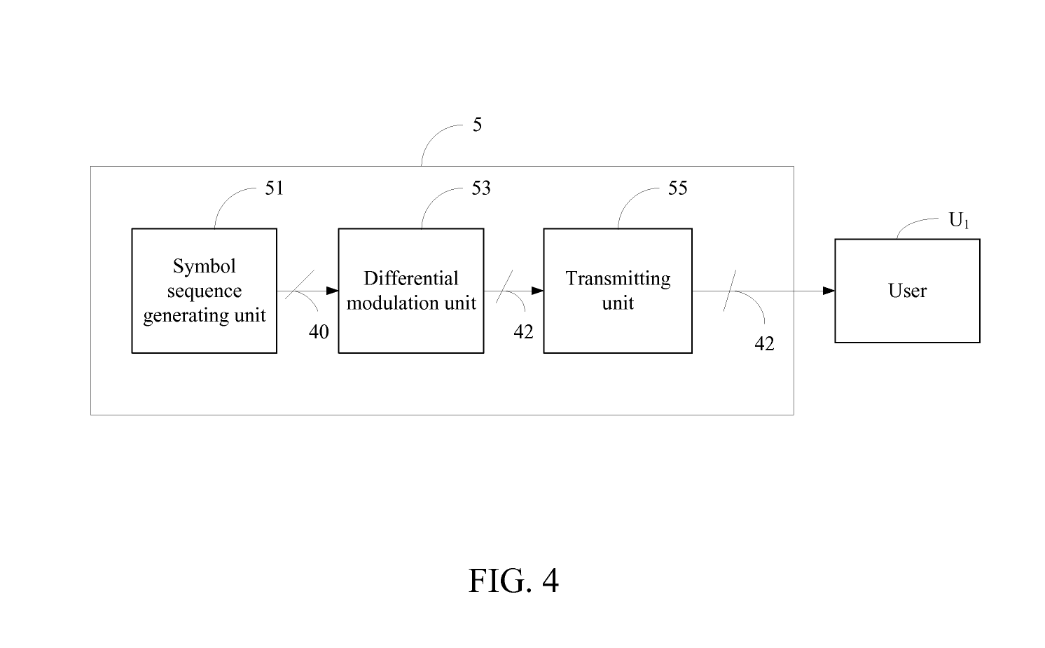

FIG. 4 is a schematic structural view of the transmitter 5 of this embodiment. As shown in FIG. 4, the transmitter 5 comprises a symbol sequence generating unit 51, a differential modulation unit 53, and a transmitting unit 55. The symbol sequence generating unit 51, the differential modulation unit 53, and the transmitting unit 55 are electrically connected to each other (directly or indirectly), and can communicate with and transfer messages between each other.

The exemplary operation of the transmitter 5 will be further described hereinafter. Firstly, the symbol sequence generating unit 51 generates a first symbol sequence 40 including a plurality of first symbols, wherein the first symbols correspond to a user U₁. Then, the differential modulation unit 53 modulates the first symbol sequence 40 into a second symbol sequence 42 including a specific symbol and a plurality of second symbols, wherein the specific symbol and any one of the second symbols correspond to one of the first symbols. Finally, the transmitting unit 55 transmits the second symbol sequence 42 to the user U₁.

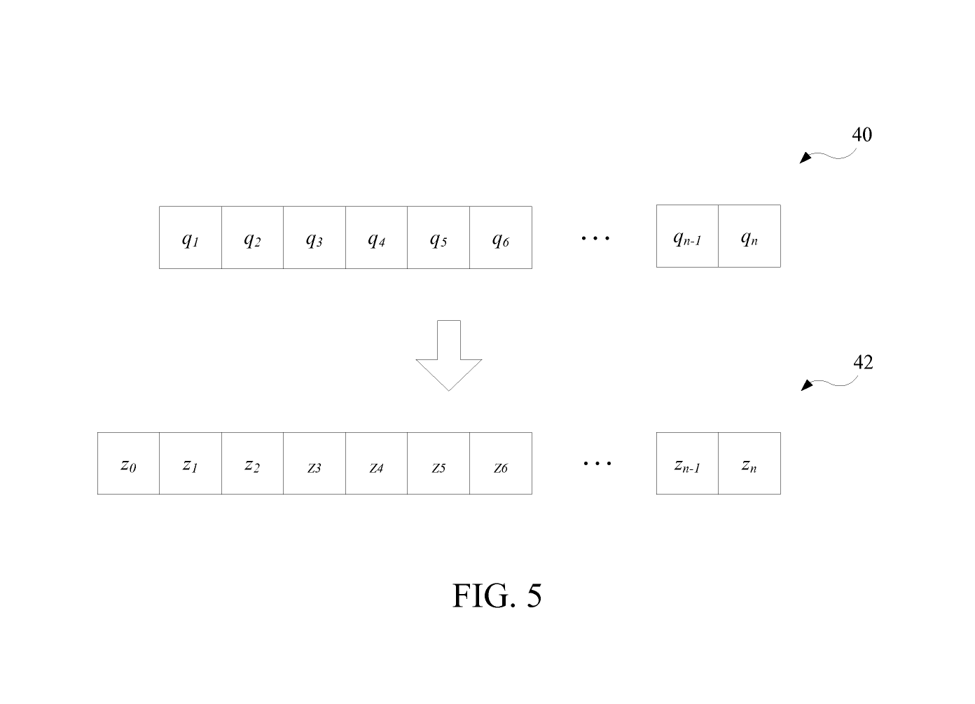

FIG. 5 is a schematic view illustrating how the first symbol sequence 40 is modulated into the second symbol sequence 42 according to this embodiment. As shown in FIG. 5, the symbol sequence generating unit 51 generates the first symbol sequence 40 including n first symbols q₁, q₂, . . . , qₙ, where the first symbols q₁, q₂, . . . , qₙ are allocated to a same user U₁.

In this embodiment, each of the first symbols q₁, q₂, . . . , qₙ is an original data symbol. In other embodiments, each of the first symbols q₁, q₂, . . . , qₙ may also be a symbol that has been processed through various phase shift keying modulations (e.g., 2PSK, QPSK, 8PSK, MPSK). In this case, the first symbols q₁, q₂, . . . , qₙ may be basically represented as e^{θ1}, e^{θ2}, . . . , e^{θn}, and θ₁, θ₂, . . . , θₙ correspond to different phases. Similarly, in other embodiments, the first symbols q₁, q₂, . . . , qₙ may also be symbols that have been processed through frequency shift keying modulation and amplitude shift keying modulation.

After the first symbol sequence 40 including the first symbols q₁, q₂, . . . , qₙ is generated by the symbol sequence generating unit 51, the differential modulation unit 53 performs differential modulation on the first symbol sequence 40 to generate the second symbol sequence 42, where the second symbol sequence 42 comprises a specific symbol z₀ and a plurality of second symbols z₁, z₂, . . . , zₙ. In detail, the differential modulation unit 53 generates the second symbols z₁, z₂, . . . , zₙ according to the following equation:

zₙ=conj(z₀)q_{N}

where conj(*) represents a conjugate operation, z₀ is the specific symbol, z_{N} is the N^{th} of the second symbols, q_{N} is the N^{th} of the first symbols, and N is a positive integer.

Based on the aforesaid equation, after having determined the specific symbol z₀ (e.g., any one of the first symbols q₁, q₂, . . . , qₙ may be chosen as the specific symbol z₀), the differential modulation unit 53 can generate the second symbol z₁ according to the specific symbol z₀ and the first symbol q₁. Then, the differential modulation unit 53 generates the second symbol z₂ according to the specific symbol z₀ and the first symbol q₂, and so on, until the n^{th} second symbol zₙ is generated.

After the second symbol sequence 42 is generated by the differential modulation unit 53, the transmitting unit 55 transmits the second symbol sequence 42 to the receiver of the user U₁ if the user U₁ intends to receive first symbols that he or she needs. The receiver of the user U₁ may perform differential demodulation on the second symbol sequence 42 according to the specific symbol z₀ to obtain the first symbols q₁, q₂, . . . , qₙ. Different from the conventional differential modulation technology, each of the plurality of the second symbols z₁, z₂, . . . , zₙ is only correlated to the specific symbol z₀ and independent from each other.

Through the aforesaid operations of the transmitter 5, once the second symbol sequence 42 is received by the receiver of the user U₁, the correlation between the noises to which adjacent symbols of the second symbols z₁, z₂, . . . , zₙ included in the second symbol sequence 42 are subjected has been effectively reduced. In other words, in the case of transmitting data with the conventional differential modulation technology, the transmitter 5 can effectively reduce the correlation between the noises to which adjacent symbols of the data symbol sequence generated by the receiver through differential demodulation are subjected. In other embodiments, the transmitter 5 may further comprise a spreading unit (not shown), wherein the spreading unit may be electrically connected to the transmitting unit 55, and spread the specific symbol z₀ and/or each of the second symbols z₁, z₂, . . . , zₙ in one of the time domain and the frequency domain by using various spreading codes before the second symbol sequence 42 is transmitted by the transmitting unit 55. In this way, the noises can be effectively suppressed, the transmission delay of the packet can be reduced remarkably, and electric power can be saved. As considering the operation of the spreading unit at the transmitter 1, after the specific symbol z₀ and the second symbol sequence 42 are received by the receiver of the user U₁, a despreading operation and the aforesaid differential demodulation will be performed in succession on the specific symbol z₀ and the second symbol sequence 42 to obtain the first symbols q₁, q₂, . . . , qₙ.

In this embodiment, the transmitting unit 55 transmits the specific symbol z₀ and the plurality of the second symbols z₁, z₂, . . . , zₙ via a single antenna (not shown). In other embodiments, the transmitting unit 55 may also comprise a plurality of antennas (not shown) which are used to alternatively transmit the specific symbol z₀, the second symbol z₁, the second symbol z₂, . . . , the second symbol zₙ sequentially. Transmitting the specific symbol z₀ and the second symbols z₁, z₂, . . . , zₙ via a plurality of antennas can produce a diversity gain and thereby improve the performance. It shall be appreciated that, the antennas included in the transmitting unit 55 can transmit the specific symbol z₀ and the second symbols z₁, z₂, . . . , zₙ alternatively in various manners.

For example, assuming that the transmitting unit 55 comprises a first antenna and a second antenna, then the transmitting unit 55 may transmit the specific symbol z₀ and the odd-numbered second symbols z₁, z₃, . . . , zₙ₋₁ via the first antenna and transmit the even-numbered second symbols z₂, z₄, . . . , zₙ via the second antenna. In other embodiments, the transmitting unit 55 may also transmit each of the second symbols z₁, z₂, . . . , zₙ randomly via any one of a plurality of antennas.

In other embodiments, in order to ensure that the specific symbol z₀ is indeed transmitted to the user U₁, the transmitter 5 may improve the probability of completely transmitting the specific symbol z₀ to the user U₁ by additionally modulating the specific symbol z₀ or increasing the energy of the specific symbol z₀ or even through a repeated transmission mechanism because all of the second symbols z₁, . . . , zₙ are correlated to the specific symbol z₀. Therefore, in other embodiments, the transmitting unit 55 may comprise a plurality of antennas (not shown) which are used to transmit the specific symbol z₀ repeatedly at different times or at different frequencies. For example, assuming that the transmitting unit 55 comprises a first antenna and a second antenna, then the transmitting unit 55 may firstly transmit the specific symbol z₀ via the first antenna, then transmit the second symbols z₁, . . . , zₙ via the first antenna and the second antenna alternatively, and finally transmit the specific symbol z₀ to the user U₁ again via the second antenna.

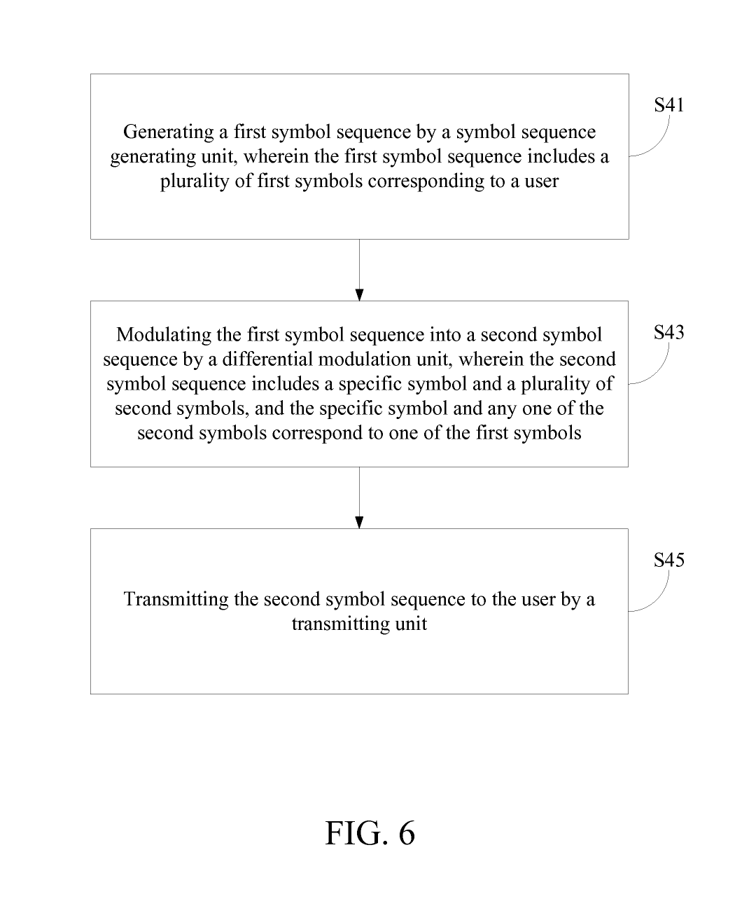

A fourth embodiment of the present invention is a transmission method for a transmitter (e.g., the transmitter 5 of the third embodiment). FIG. 6 is a flowchart diagram of the transmission method of this embodiment. As shown in FIG. 6, step S41 is executed to generate a first symbol sequence by a symbol sequence generating unit, wherein the first symbol sequence includes a plurality of first symbols corresponding to a user. Step S43 is executed to modulate the first symbol sequence into a second symbol sequence by a differential modulation unit, wherein the second symbol sequence includes a specific symbol and a plurality of second symbols, and the specific symbol and any one of the second symbols correspond to one of the first symbols. Step S45 is executed to transmit the second symbol sequence to the user by a transmitting unit.

In other embodiments, the differential modulation unit generates the second symbols according to the following equation:

z_{N}=conj(z₀)q_{N}

where conj(*) represents a conjugate operation, z₀ is the specific symbol, zₙ is the N^{th} of the second symbols, q_{N} is the N^{th} of the first symbols, and N is a positive integer.

In other embodiments, the transmission method of this embodiment further comprises the following step of: spreading the specific symbol and/or each of the second symbols in one of the time domain and the frequency domain by a spreading unit before the second symbol sequence is transmitted by the transmitting unit.

In other embodiments, the transmission method of this embodiment further comprises the following step of transmitting the second symbols by a plurality of antennas alternatively.

In other embodiments, the transmission method of this embodiment further comprises the following step of transmitting the specific symbol repeatedly by a plurality of antennas at different times or different frequencies.

In other embodiments, each of the first symbols is a symbol processed through phase shift keying modulation.

In addition to the aforesaid steps, the transmission method of this embodiment can further execute all the operations and functions corresponding to the transmitter 5 of the third embodiment. The undisclosed steps of this embodiment will be readily appreciated by those of ordinary skill in the art based on the explanation of the third embodiment, and thus will not be further described herein.

According to the above descriptions, the transmitter of the third embodiment and the transmission method of the fourth embodiment can perform special differential modulation on a data symbol sequence so that the modulated differential symbol sequence comprises a specific symbol and a plurality of differential symbols. Each of the differential symbols is correlated to the specific symbol and independent from each other. As a result, the correlation between the noises to which adjacent symbols of the data symbol sequence generated by the receiver through differential demodulation are subjected can be reduced. In other words, the correlation between the noises to which adjacent symbols in the symbols needed by each user are subjected will be reduced. Therefore, as compared to the conventional differential modulation technology, the transmitter of the third embodiment and the transmission method of the fourth embodiment can effectively reduce the correlation between the noises to which adjacent symbols of the data symbol sequence generated by the receiver through differential demodulation are subjected.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A transmitter, comprising:
a symbol sequence generating unit, being configured to generate a first symbol sequence, wherein the first symbol sequence includes a plurality of first symbols in which adjacent symbols correspond to different users;
a differential modulation unit, being configured to modulate the first symbol sequence into a second symbol sequence, wherein the second symbol sequence includes a plurality of second symbols in which every two adjacent symbols correspond to one of the first symbols; and
a transmitting unit, being configured to transmit the second symbol sequence to at least one of the users.

2. The transmitter as claimed in claim 1, wherein the differential modulation unit generates the second symbols according to the following equation:
d_{N}=conj(d_{N-1})q_{N}
where conj(*) represents a conjugate operation, d₀ is a preset value, d_{N} is the N^{th} of the second symbols, q_{N} is the N^{th} of the first symbols, and N is a positive integer.

3. The transmitter as claimed in claim 1, further comprising a spreading unit, wherein the spreading unit spreads each of the second symbols in one of the time domain and the frequency domain before the second symbol sequence is transmitted by the transmitting unit.

4. The transmitter as claimed in claim 1, wherein the transmitting unit comprises a plurality of antennas configured to transmit the second symbols alternatively.

5. The transmitter as claimed in claim 1, wherein each of the first symbols is a symbol processed through phase shift keying modulation.

6. A transmission method for a transmitter, comprising:
generating a first symbol sequence by a symbol sequence generating unit, wherein the first symbol sequence includes a plurality of first symbols in which adjacent symbols correspond to different users;
modulating the first symbol sequence into a second symbol sequence by a differential modulation unit, wherein the second symbol sequence includes a plurality of second symbols in which every two adjacent symbols correspond to one of the first symbols; and
transmitting the second symbol sequence to at least one of the users by a transmitting unit.

7. The transmission method as claimed in claim 6, wherein the differential modulation unit generates the second symbols according to the following equation:
d_{N}=conj(d_{N-1})q_{N}
where conj(*) represents a conjugate operation, d₀ is a preset value, d_{N} is the N^{th} of the second symbols, q_{N} is the N^{th} of the first symbols, and N is a positive integer.

8. The transmission method as claimed in claim 6, further comprising:
spreading each of the second symbols in one of the time domain and the frequency domain by a spreading unit before the second symbol sequence is transmitted by the transmitting unit.

9. The transmission method as claimed in claim 6, wherein the step of transmitting the second symbol sequence further includes:
transmitting the second symbols by a plurality of antennas alternatively.

10. The transmission method as claimed in claim 6, wherein each of the first symbols is a symbol processed through phase shift keying modulation.

11. A transmitter, comprising:
a symbol sequence generating unit, being configured to generate a first symbol sequence, wherein the first symbol sequence includes a plurality of first symbols corresponding to a user;
a differential modulation unit, being configured to modulate the first symbol sequence into a second symbol sequence, wherein the second symbol sequence includes a specific symbol and a plurality of second symbols, and the specific symbol and any one of the second symbols correspond to one of the first symbols; and
a transmitting unit, being configured to transmit the second symbol sequence to the user.

12. The transmitter as claimed in claim 11, wherein the differential modulation unit generates the second symbols according to the following equation:
zₙ=conj(z₀)q_{N}
where conj(*) represents a conjugate operation, z₀ is the specific symbol, z_{N} is the Nt^{h} of the second symbols, q_{N} is the N^{th} of the first symbols, and N is a positive integer.

13. The transmitter as claimed in claim 11, further comprising a spreading unit, wherein the spreading unit spreads each of the second symbols and the specific symbol in one of the time domain and the frequency domain before the second symbol sequence is transmitted by the transmitting unit.

14. The transmitter as claimed in claim 11, wherein the transmitting unit comprises a plurality of antennas configured to transmit the second symbols alternatively.

15. The transmitter as claimed in claim 11, wherein the transmitting unit comprises a plurality of antennas configured to transmit the specific symbol repeatedly at different times.

16. The transmitter as claimed in claim 11, wherein each of the first symbols is a symbol processed through phase shift keying modulation.

17. A transmission method for a transmitter, comprising:
generating a first symbol sequence by a symbol sequence generating unit, wherein the first symbol sequence includes a plurality of first symbols corresponding to a user;
modulating the first symbol sequence into a second symbol sequence by a differential modulation unit, wherein the second symbol sequence includes a specific symbol and a plurality of second symbols, and the specific symbol and any one of the second symbols correspond to one of the first symbols; and
transmitting the second symbol sequence to the user by a transmitting unit.

18. The transmission method as claimed in claim 17, wherein the differential modulation unit generates the second symbols according to the following equation:
Z_{N}=conj(z₀)q_{N}
where conj(*) represents a conjugate operation, z₀ is the specific symbol, z_{N} is the N^{th} of the second symbols, q_{N} is the N^{th} of the first symbols, and N is a positive integer.

19. The transmission method as claimed in claim 17, further comprising:
spreading each of the second symbols and the specific symbol in one of the time domain and the frequency domain by a spreading unit before the second symbol sequence is transmitted by the transmitting unit.

20. The transmission method as claimed in claim 17, wherein the step of transmitting the second symbol sequence further includes:
transmitting the second symbols by a plurality of antennas alternatively.

21. The transmission method as claimed in claim 17, wherein the step of transmitting the second symbol sequence further includes:
transmitting the specific symbol by a plurality of antennas repeatedly at different times.

22. The transmission method as claimed in claim 17, wherein each of the first symbols is a symbol processed through phase shift keying modulation.
